(19) United States
(12) Patent Application Publication
(10) Pub. No.: US 2011/0157481 A1
(43) Pub. Date: Jun. 30, 2011

(54) LIGHTING DEVICE, DISPLAY DEVICE AND TELEVISION RECEIVER

(75) Inventor: Daisuke Teragawa, Osaka-shi (JP)

(73) Assignee: SHARP KABUSHIKI KAISHA, Osaka-shi, Osaka (JP)

(21) Appl. No.: 13/055,148

(22) PCT Filed: Jun. 11, 2009
(86) PCT No.: PCT/JP2009/060667

§ 371 Date: Jan. 21, 2011

(30) Foreign Application Priority Data
Aug. 20, 2008 (JP) 2008-212119

(51) Int. Cl. H04N 5/66; G02F 1/13357; G02F 1/1335

(52) U.S. Cl. 348/739; 362/97.1; 362/97.2; 349/61; 348/E05.133

(57) ABSTRACT

A backlight unit 12 includes cold cathode tubes 18, a chassis 14 and connectors 22. Each cold cathode tube 18 has outer leads 18b at ends. The chassis 14 houses the cold cathode tubes 18. The connectors 22 are mounted to the chassis 14, connected to the outer leads 18b and configured to be movable relative to the chassis 14 in axial directions of the cold cathode tubes 18. When the cold cathode tubes 18 move relative to the chassis 14, the connectors 22 can move relative to the chassis 14 in the same directions. Therefore, frictions are less likely to occur in contact areas between the outer leads 18b of each cold cathode tube 18 and the respective connectors 22 and thus abnormal sounds or abrasions are less likely to occur.

### TECHNICAL FIELD

The present invention relates to a lighting device, a display device and a television receiver.

### BACKGROUND ART

A liquid crystal display device used as a liquid crystal television receiver requires a backlight unit separately from a liquid crystal panel because the liquid crystal panel does not emit light. The backlight unit is arranged behind the liquid crystal panel (on a opposite side from the display surface side). It includes a chassis, a number of cold cathode tubes, a plurality of optical members (including a diffuser sheet) and an inverter board. The chassis has an opening on the liquid crystal panel side. The cold cathode tubes are hosed in the chassis. The optical members are arranged so as to cover the opening of the chassis to effectively direct light emitted from the cold cathode tubes toward the liquid crystal panel. The inverter board is configured to supply power to the cold cathode tubes.

An example configuration for electrically connecting the cold cathode tubes to the inverter board is disclosed in Patent Document 1. In this configuration, the cold cathode tubes are electrically connected to the inverter board via connectors. Specifically, outer leads project from the respective ends of the glass tubes of the cold cathode tubes. Each connector includes a housing mounted to the chassis and a connecting terminal mounted to the housing and connected to the outer lead and the inverter board. The connecting terminal has a pair of contact parts that pinch the outer lead.
Patent Document 1: Japanese Published Patent Application No. 2007-95671

### Problem to be Solved by the Invention

When the cold cathode tubes in the backlight unit having the above configuration turn on, the glass tubes may be thermally expanded or backlash may be created between the cold cathode tubes and the chassis due to external vibration. As a result, the outer leads may change relative positions to the respective connectors, and the outer leads may rub against the respective connecting terminals, which may produce squeak noises or abrasions in contact areas of the outer leads and the connecting terminals.

### DISCLOSURE OF THE PRESENT INVENTION

The present invention was made in view of the foregoing circumstances. An object of the present invention is to reduce abnormal noises and abrasions.

### Means for Solving the Problem

A lighting device of the present invention includes a linear light source, a chassis and connectors. The linear light source has external connection portions at ends. The chassis houses the linear light source. The connectors are mounted to the chassis, connected to the external connection portions and configured to be movable relative to the chassis in an axial direction of the linear light source.

When the linear light source moves relative to the chassis in the axial direction thereof, the connectors also move relative to the chassis in the same direction. Therefore, frictions are less likely to occur in contact areas between the external connection portions of the linear light source and the respective connectors.

### BRIEF DESCRIPTION OF THE DRAWINGS

FIG. 1 is an exploded perspective view illustrating a general construction of a television receiver according to a first embodiment of the present invention;

FIG. 2 is an exploded perspective view illustrating a general construction of a liquid crystal display device included in the television receiver;

FIG. 3 is a cross-sectional view illustrating the liquid crystal display device along the long-side direction;

FIG. 4 is a plan view of a chassis with cold cathode tubes and connectors mounted;

FIG. 5 is a rear view of the chassis with the cold cathode tubes and the connectors mounted;

FIG. 6 is a cross-sectional view illustrating connection between the cold cathode tube, the connector and an inverter board;

FIG. 7 is a cross-sectional view illustrating the connector moved relative to the chassis from the original position;

FIG. 8 is a front view illustrating a terminal pressing member fitted onto the housing in the first fitting position;

FIG. 9 is a plan view illustrating the terminal pressing member fitted onto the housing in the first fitting position;

FIG. 10 is a cross-sectional view illustrating connection between the cold cathode tube, the connector and the inverter board;

FIG. 11 is a cross-sectional view illustrating the connector moved relative to the chassis;

FIG. 12 is a mounting structure of the connector to the chassis according to the third embodiment of the present invention; and

FIG. 13 is a cross-sectional view illustrating the connector moved relative to the chassis.

### BEST MODE FOR CARRYING OUT THE INVENTION

### First Embodiment

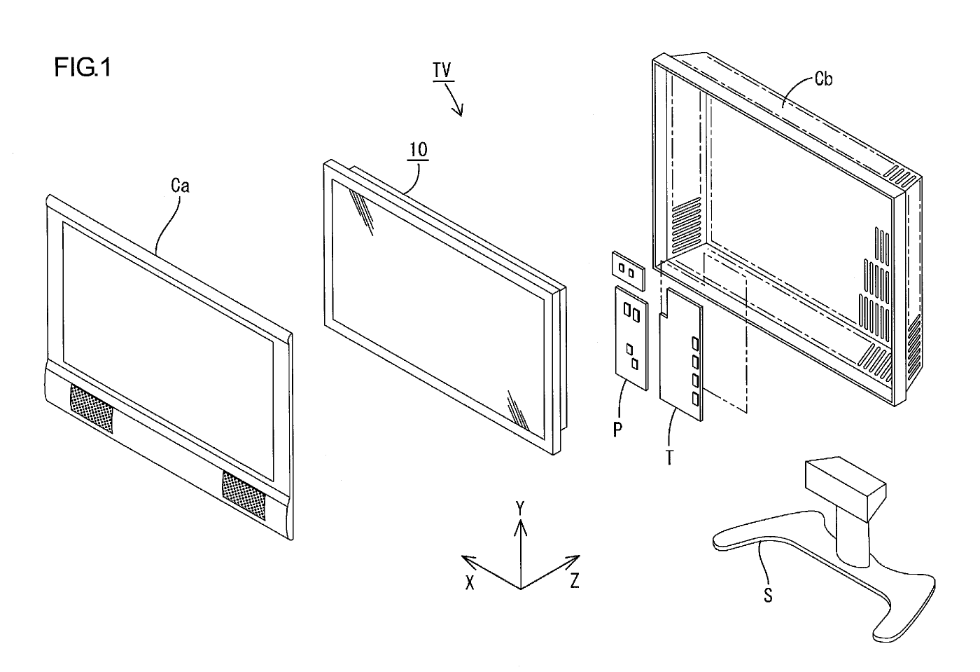

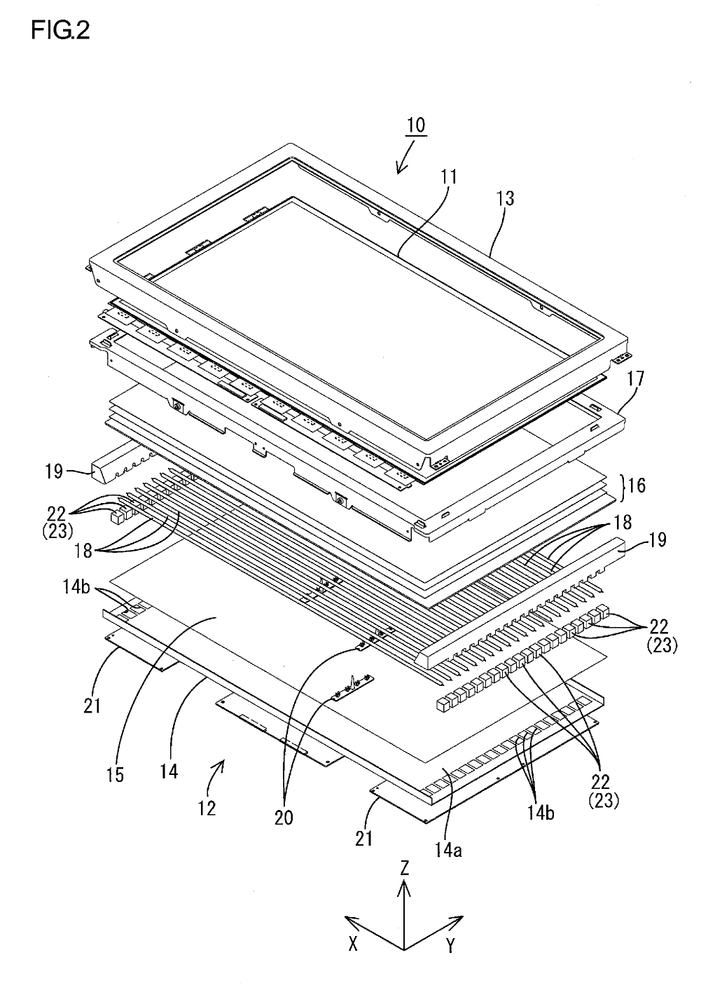

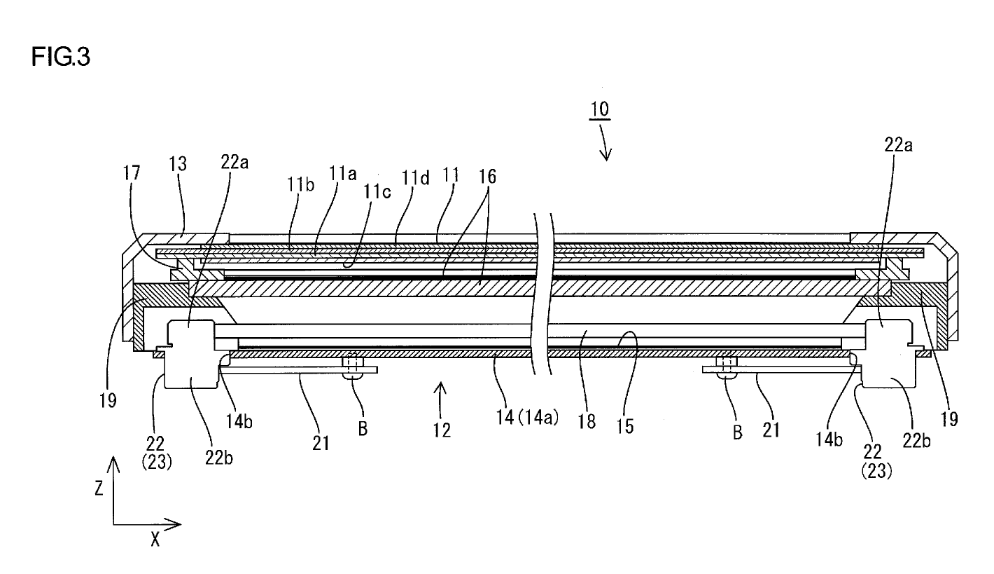

The first embodiment of the present invention will be explained with reference to FIGS. 1 to 9. In this embodiment, a liquid crystal display device 10 will be explained. X-axes, Y-axes and Z-axes are shown in some figures. Each of the X-axes, the Y-axes and Z-axes indicates an X-axis direction, a Y-axis direction and a Z-axis direction of the liquid crystal display device 10, respectively. In FIGS. 2 and 3, the top and the bottom correspond to the front and the rear of the liquid crystal display device 10, respectively.

As illustrated in FIG. 1, a television receiver TV of this embodiment includes the liquid crystal display device 10 (a display device), front and rear cabinets Ca, Cb that house the liquid crystal display device 10 therebetween, a power source P and a tuner T. An overall shape of the liquid crystal display device 10 is a landscape rectangular. As illustrated in FIG. 2, the liquid crystal display device 10 includes a liquid crystal panel 11, which is a display panel, and a backlight unit 12 (a lighting device), which is an external light source. They are held together by a bezel 13.

Next, the liquid crystal panel 11 and the backlight unit 12 included in the liquid crystal display device 10 will be explained one by one. As illustrated in FIG. 3, the liquid crystal panel 11 has a pair of glass substrates 11a and 11b bonded together with a predetermined gap therebetween and liquid crystals (not shown) sealed between the substrates. On one of the glass substrate 11a, switching components (e.g., TFTs) connected to source lines and gate lines that are perpendicular to each other, pixel electrodes connected to the switching components and an alignment film are provided. On the other glass substrate 11b, a color filter having red (R), green (G) and blue (B) color sections arranged in a predetermined matrix, a counter electrode and an alignment film are provided. Image data that is necessary for displaying an image and various control signals are sent from a drive circuit (not shown) to the source lines, the gate lines and the counter electrode. Polarizing plates 11c and 11d arranged on the outer surfaces of the glass substrates 11a and 11b, respectively.

As illustrated in FIGS. 2 and 3, the backlight unit 12 is a so-called direct backlight that is arranged closely behind the liquid crystal panel 11. It includes a chassis 14, a reflection sheet 15, a plurality of optical members 16, a frame 17, a plurality of cold cathode tubes 18 (linear light sources), holders 19, and lamp clips 20. The chassis 14 has a landscape rectangular overall shape and an opening in a surface on the front side (i.e., the light output side or the liquid crystal panel 11 side). The reflection sheet 15 is placed inside the chassis 14. The optical members 16 are attached to the chassis 14 so as to cover the opening. The frame 17 holds the optical members 16. The cold cathode tubes 18 are arranged parallel to each other inside the chassis. The holders 19 block light at ends of the cold cathode tubes 18 and have light reflectivity. Each lamp clip 20 holds the middle section of the corresponding cold cathode tube 18. The backlight unit 12 further includes inverter boards 21 (power circuit boards), connectors 22 and holding members 23. The inverter boards 21 are arranged on the rear surface of the chassis 14. The connectors 22 make electrical connection between the inverter boards 21 and the cold cathode tubes 18. The holding members 23 hold the connectors 22 to the chassis 14.

The chassis 14 is made of metal, such as aluminum. It includes a bottom plate 14a having a rectangular shape in plan view similar to the liquid crystal panel 11 and side plates standing upright from respective edges of the bottom plate 14a. The long dimension and the short dimension of the bottom plate 14a match the X-axis and the Y-axis shown in each figure. The bottom plate 14a is arranged behind the cold cathode tubes 18 so as to face the cold cathode tubes 18. Namely, the bottom plate 14a is arranged on a side opposite from the light output side with respect to the cold cathode tubes 18. The reflection sheet 15 is made of synthetic resin in white having high light reflectivity, and placed so as to cover about an entire inner surface of the chassis 14. It has a function of reflecting light from the cold cathode tubes 18 toward the optical members 16 (on the light output side).

The optical members 16 have a rectangular shape in plan view similar to the bottom plate 14a of the chassis 14 or the liquid crystal panel 11. They are made of synthetic resin capable of light transmission, and arranged between the cold cathode tubes 18 on the rear side and the liquid crystal panel 11 on the front side. The optical members 16 include a diffuser plate, a diffuser sheet, a lens sheet and a brightness enhancement sheet arranged in this order from the rear side. The linear light from each cold cathode tube 18 is converted to uniform planar light.

The frame 17 has a frame shape along the outer rims of the liquid crystal panel 11 and the optical members 16. It is arranged on the front side of the optical members 16 so as to hold the outer rims of the optical members 16 between the side plates of the chassis 14 and the holders 19. The frame 17 holds the liquid crystal panel 11 from the rear side. The liquid crystal panel 11 is sandwiched between the frame and the bezel 13 that is arranged on the front side of the liquid crystal panel 11.

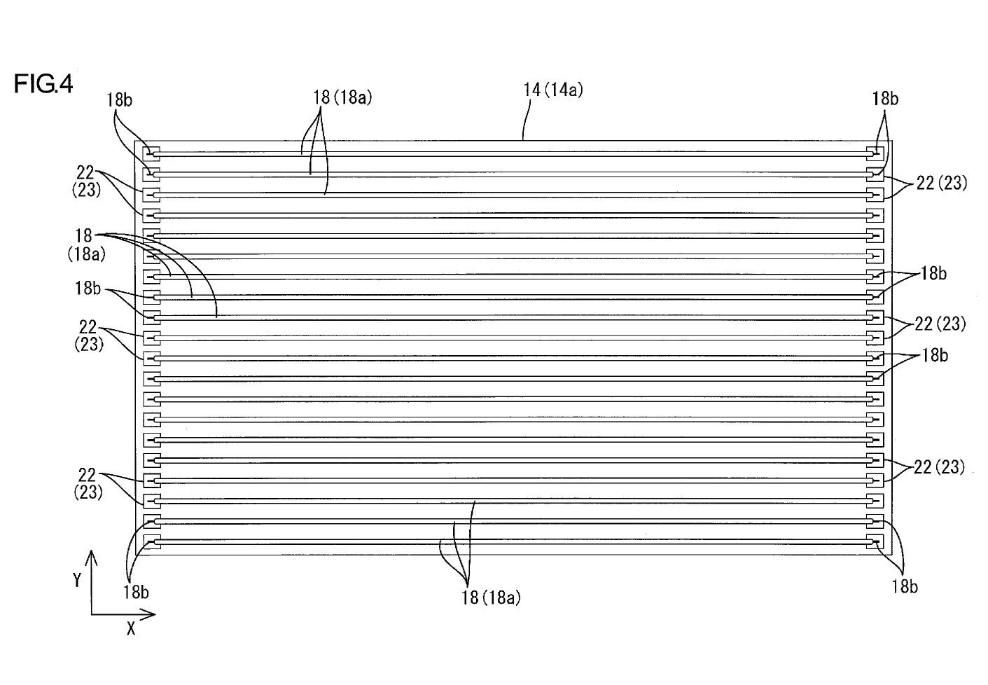

The cold cathode tubes 18 are one kind of linear light sources (or tubular light sources). As illustrated in FIG. 4, the cold cathode tubes 18 are mounted to the chassis 14 with the axes thereof set along the long-side direction (i.e., the X-axis direction), and arranged substantially parallel to each other with predetermined intervals along the short-side direction of the chassis 14 (i.e., the Y-axis direction).

The cold cathode tubes 18 are one kind of discharge tubes. Each of them includes an elongated glass tube 18a, a pair of electrodes (not shown) and a pair of outer leads 18b. Each glass tube 18a has a circular cross section and closed ends. The electrodes are enclosed in the glass tube 18a and located at the respective ends of the glass tube 17a. The outer leads 18b project from the respective ends of the glass tube 18a to outside. The cold cathode tube 18 is a so-called straight-tube-type cold cathode tube that includes the straight glass tube 18a and the electrodes arranged at two different locations (left and right sides in FIG. 3 or 4). The glass tube 18a encloses a luminescent material such as mercury and a fluorescent material applied to the inner surface thereof (not shown). The outer leads 18b are made of metal having electrical conductivity. Each outer lead 18b has a substantially elongated column shape that extends from the end of the glass tube 18a to outside (opposite to the electrode) along the axial direction thereof (i.e., the X-axis direction). When an inner end of the outer lead 18b is connected to the electrode inside the glass tube 18a, the outer lead and the electrode are at the same potential.

The holders 19 are made of synthetic resin in white having high light reflectivity. As illustrated in FIG. 2, the holders 19 are arranged so as to extend along the short sides of the chassis 14. Each holder 19 has a substantially box shape having an opening in the rear surface. The holders 19 are mounted to the chassis 14 at the respective ends of the long dimension of the chassis 14 so as to collectively cover the respective ends (i.e., non-light emitting sections) of the cold cathode tubes 18 arranged parallel to each other.

The lamp clips 20 are made of synthetic resin in white having high light reflectivity. They are scattered in predetermined distribution patterns on the bottom plate 14a of the chassis 14. The lamp clips 20 are fixed to the bottom plate 14a of the chassis 14 and configured to hold the middle sections (light emitting sections) of the cold cathode tubes 18 between the ends of the cold cathode tubes 18. Therefore, the cold cathode tubes 19 can be held with a predetermined distance away from the bottom plate 14a of the chassis 14.

Next, the inverter boards 21 and the connectors 22 required for supplying power to the cold cathode tubes 18 will be explained in detail. Each inverter board 21 includes a substrate made of synthetic resin (e.g., paper phenolic resin and glass-epoxy resin), predetermined circuit patterns formed on the substrate, and electronic components including a transformer mounted on the substrate (both circuit patterns and the electronic components are not shown). Each inverter board 21 is connected to the power source P of the liquid crystal display device 10. It has a function of controlling the turn-on and turn-off of the cold cathode tubes 18. For example, it steps up an input voltage from the power source P and outputs an output voltage higher than the input voltage. The output voltage is then input to the cold cathode tubes 18.

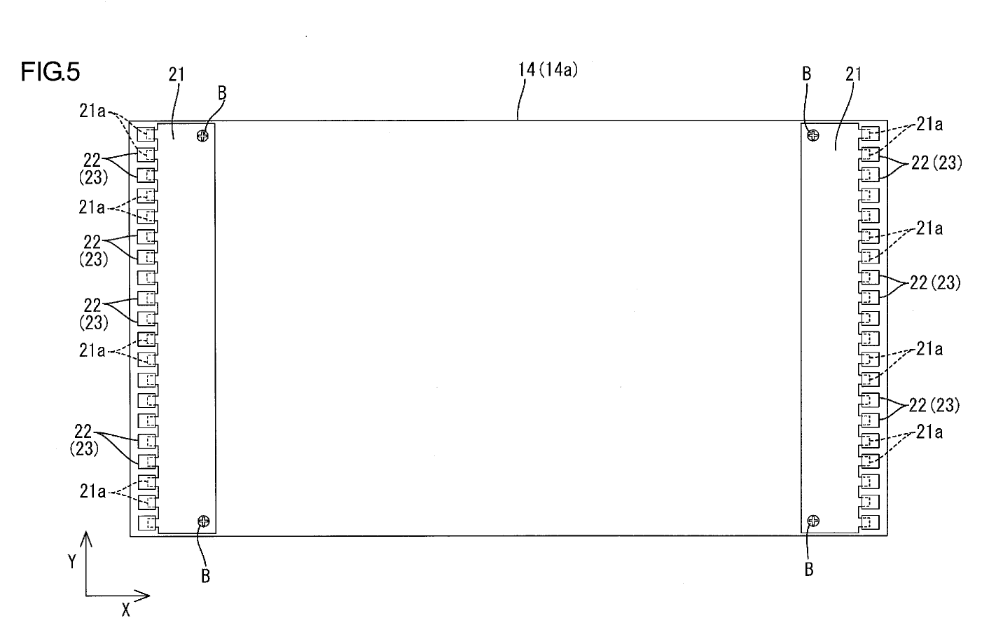

As illustrated in FIG. 5, the inverter boards 21 are mounted to the rear surface of the bottom plate 14a of the chassis (on the surface opposite from the surface on which the cold cathode tubes 18 are mounted) in a pair. They are arranged near the ends of the long dimension of the bottom plate 14a. Each inverter 21 has a rectangular shape in plan view. It is fixed to the bottom plate 14a with screws B such that the plate surface thereof is substantially parallel to the plate surface of the bottom plate 14a of the chassis 14, and the long-side direction thereof matches the short-side direction of the bottom plate 14a. The plate surface of the bottom plate 14a is parallel to a plane defined by the X-axis and the Y-axis, and perpendicular to the Z-axis corresponding to the thickness direction of the liquid crystal display device 10. The short-side direction of the bottom plate 14a corresponds to the Y-axis and perpendicular to the axis of the cold cathode tubes 18. Connection tabs 21a project from parts of one of the long edges of each inverter board 21 on the outer side (facing the connectors 22) to outside (on the connector 22 side) along the X-axis direction. The connection tabs 21a are connected and fitted to the respective connectors 22, which will be explained later. The connection tabs 21a are provided at equal intervals along the long side of the inverter board 21 (i.e., the Y-axis direction or the parallel arrangement direction of the cold cathode tubes 18 and the connectors 22). They form substantially a comb-like overall shape.

As illustrated in FIG. 3, each connector 22 makes electrical connection between the corresponding inverter board 21 and the corresponding cold cathode tube 18. It includes a light source connecting portion 22a that is connected to the outer lead 18b of the cold cathode tube 18 at one end and a board connecting portion 22b that is connected to the connection tab 21a of the inverter board 21 at the other end. The output voltage output from the inverter board 21 can be applied to the outer lead 18b and the electrode of the cold cathode tube 18 via the connector 22. As illustrated in FIGS. 4 and 5, the connectors 22 are arranged in locations corresponding to the respective ends of the cold cathode tubes 18 (or outer leads 18b) on the chassis 14. Namely, a plurality of the connectors 22 (the same number as the cold cathode tubes 18) are arranged at either ends of the long dimension of the bottom plate 14a in pairs along the short sides of the bottom plate 14a (in the Y-axis direction or the parallel arrangement direction of the cold cathode tubes 18). The intervals between the connectors 22 are about equal to the intervals of the cold cathode tubes 18 or the intervals of the connection tabs 21a. They are equal intervals. The vertical locations of the connectors 22 substantially match the cold cathode tubes 18 and the connection tabs 21a.

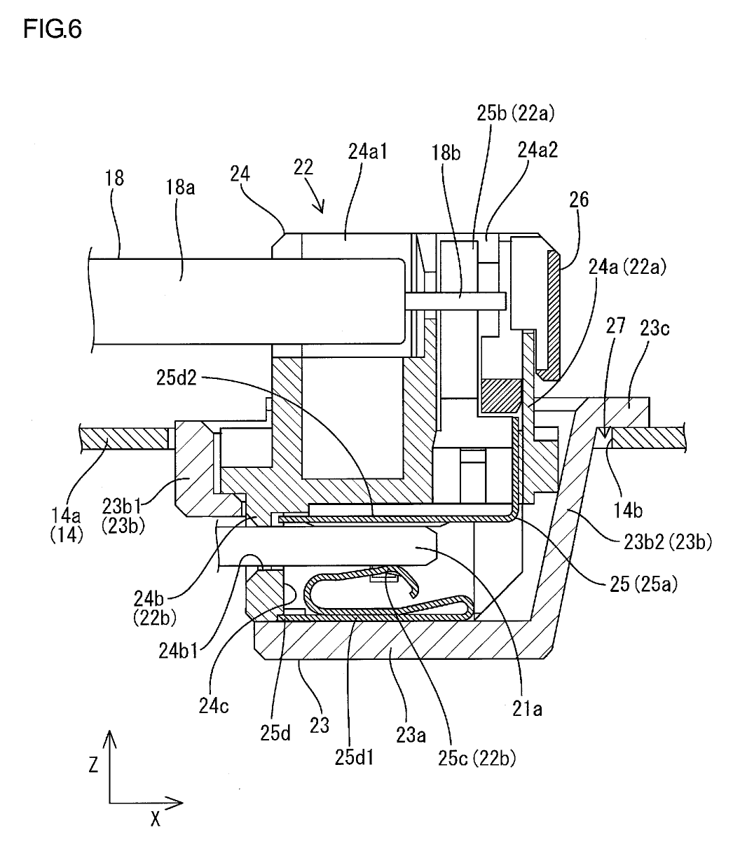

Specifically, each connector 22 has a substantially block-like overall shape. As illustrated in FIG. 6, it is fitted in a mounting hole 14b formed in the bottom plate 14a of the chassis via a holding member 23, which will be explained later. The connector 22 penetrates through the bottom plate 14a in the thickness direction of the bottom plate 14a (i.e., the Z-axis direction) when it is mounted to the bottom plate 14a. The light source connecting portion 22a is provided in a part of the connector 22 projecting from the bottom plate 14a to the front side. The board connecting portion 22b is provided in a part of the connector 22 projecting from the bottom plate 14a to the rear side. The connector 22 includes a housing 24, a connecting terminal 25 and a terminal pressing member 26. The hosing 24 is made of synthetic resin having insulation properties. The connecting terminal 25 is made of metal having electrical conductivity and housed in the housing 24. The terminal pressing member 26 is fitted onto the housing 24.

The housing 24 includes a light source fitting portion 24a in which the end of the cold cathode tube 18 is fitted at one end in addition to the light source connecting portion 22a. It further includes a board fitting portion 24b in which the connection tab 21a of the inverter board 21 can be fitted at the other end in addition to the board connecting portion 22b. The light source fitting portion 24a opens along the Z-axis direction toward the front (i.e., the light output side) and along the X-axis direction (along the axial direction of the cold cathode tube 18) toward the inside. Therefore, the end of the cold cathode tube 18 can be inserted from the front side along the Z-axis direction and fitted. The end of the glass tube 18a of the cold cathode tube 18 is inserted in an inner section 24a1 of the light source fitting portion 24a. The outer lead 18b of the cold cathode tube 18 is inserted in an outer section 24a2 of the light source fitting portion 24a. An end surface and a periphery of the end of the glass tube 18a is brought in contact with the inner portion 24a1 of the light source fitting portion 24a. Each board fitting portion 24b has a board insertion hole 24b1 that opens along the X-axis direction (i.e., the axial direction of the cold cathode tube 18) toward the inner side. The corresponding connection tab 21a of the inverter board 21 is inserted from the inner side along the X-axis direction and fitted. The board fitting portion 24b has a terminal mounting hole 24c that opens along the Z-axis direction toward the rear side. The connecting terminal 25, which will be explained next, is inserted in the terminal mounting hole 24c from the rear side along the Z-axis direction. The terminal mounting hole 24c continues to the outer section 24a2 of the light source fitting portion 24a and thus penetrates through the housing 24 in the Z-axis direction.

The connecting terminal 25 includes a base portion 25a having a L-shaped cross section. The light source connecting portion 22a and light source contacts 25b are provided at one of ends of the base portion 25a. The light source contact 25b is in contact with the outer lead 18b of the cold cathode tube 18 and electrically connected. The board connecting portion 22b and a board contact 25c are provided at the other end of the base portion 25a. The board contact 25c is in contact with a terminal (not shown) of the connection tab 21a of the inverter board 21 and electrically connected.

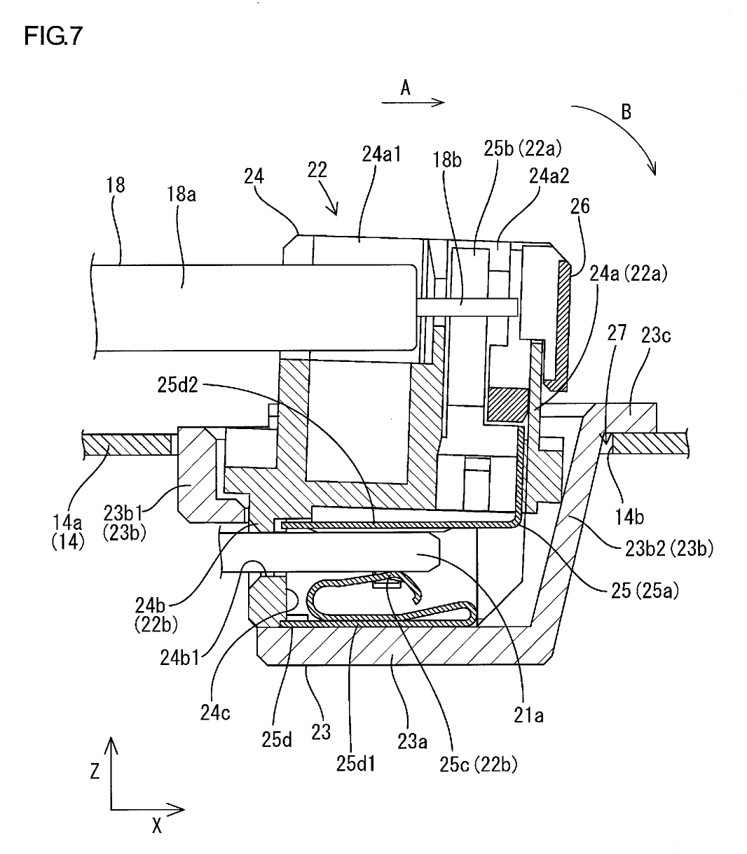

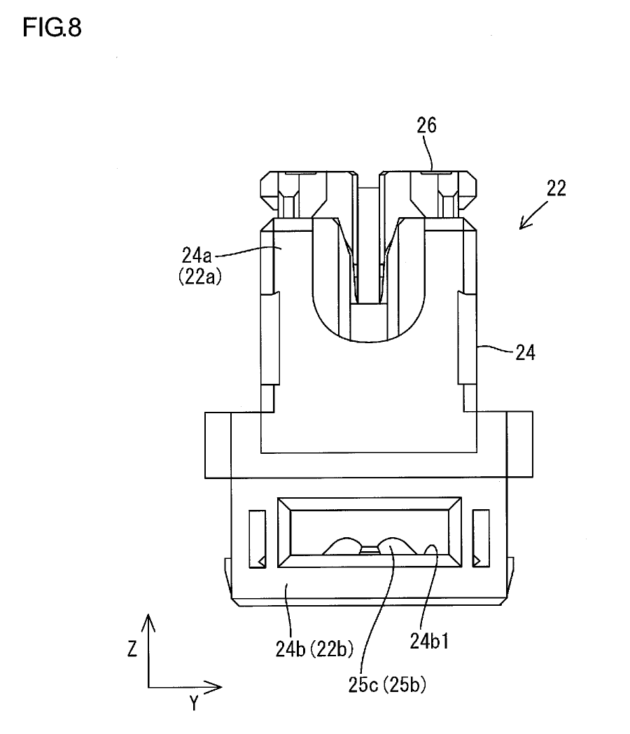

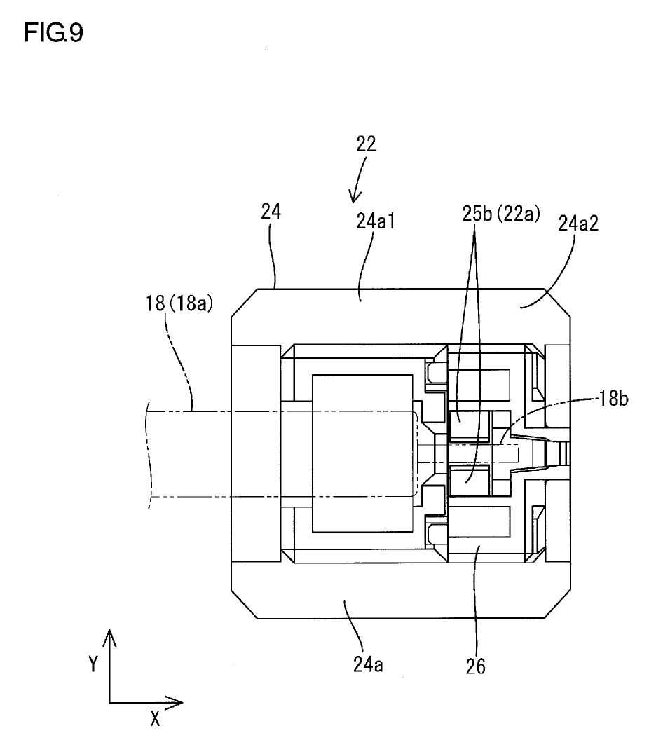

The light source contacts 25b are arranged inside the outer portion 24a2 of the light source fitting portion 24a of the housing 24. They are provided in a pair and arranged in the Y-axis direction (perpendicular to the axial direction of the cold cathode tube 18 and the fitting direction of the outer lead 18b) so as to face each other (see FIG. 9). The light source contacts 25b are elastically deformable so as to move away from each other, that is, they can be elastically deformed outward in the Y-axis direction. The outer lead 18b of the cold cathode tube 18 is fitted between the light source contacts 25b. The outer lead 18b is held with elastic forces such that the outer lead 18b is pinched between the light source contacts 25b. The terminal pressing member 26 that is a separately prepared part from the housing 24 is fitted from outside light source fitting portion 24a of the housing 24. The terminal pressing member 26 has a pressing portion (not shown). The pressing portion is positioned away from the light source contacts 25b when the terminal pressing member 26 is at the first position at which it projects from the light source fitting portion 24a on the front side (see FIGS. 8 and 9). The pressing portion is engaged with the light source contacts 25b and forces are applied to the light source contacts 25 in directions that the light source contacts 25 get close to each other when the terminal pressing member 26 is in the second position in which it is placed in the light source fitting portion 24a (see FIGS. 6 and 7).

The base portion 25a has a barrel-like portion 25d at the other end. The barrel-like portion 25d opens in the X-axis direction. A board contacts 25c projects from an outer wall 25d1 of the barrel-like portion 25d located on an outer side in the Z-axis direction in a folded form. The barrel-like portion 25d and the board contact 25c are provided inside the board fitting portion 24b of the housing 24 so as to face the board insertion hole 24b1. The board contact 25c is elastically deformable outward in the Z-axis direction. The connection tab 21a of the inverter board 21 is held between the inner wall 25d2 of the barrel-like portion 25d located on an inner side in the Z-axis direction and the board contact 25c with elastic forces.

The holding member 23 for holding the connector 22 is fitted in the mounting hole 14b of the bottom plate 14a of the chassis 14 as illustrated in FIG. 6. The holding member 23 is made of synthetic resin. The holding member 23 having a substantially box shape with an opening on the front side is attached to the connector 22 from the rear side in the Z-axis direction. The holding member 23 covers the rear half of the connector 22, that is, the board connecting portion 22b when the holding member 23 is attached to the connector 22. The holding member 23 includes a bottom 23a located behind the board connecting portion 22b and four sidewalls 23b that rise from the respective edges of the bottom 23a and form a substantially barrel shape. The bottom 23a covers the terminal mounting hole 24c of the housing 24 and holds the connecting terminal 25 so that the connecting terminal 25 does not fall. The sidewall 23b1 among the sidewalls 23b located on an inner side in the X-axis direction has a cutout in a location corresponding to the board insertion hole 24b1 for receiving the inverter board 21. The sidewall 23b2 among the sidewalls 23b located on an outer side in the X-axis direction is sloped with respect to the Z-axis direction so as to project gradually outward from the bottom 23a side to the top. A stopper 23c projects outward from the top (i.e., an end on the front side) of the sidewall 23b2 along the X-axis direction. The stopper 23C is placed against the edge of the mounting hole 14b from the front side so as to retain the holding member 23 in the mounding position with respect to the chassis 14. Stoppers 23c are also provided at the top ends of the sidewalls arranged in the Y-axis direction among the sidewalls 23b although those are not shown in figures. The connector 22 is held in the mounting position with a specific holding structure (not shown) in the holding member 23.

The connectors 22 are configured to be movable relative to the chassis 14 in the X-axis direction, that is, the axial direction of the cold cathode tube 18. A part of each holding member 23 for holding the corresponding connector 22 can move relative to the chassis 14 in the X-axis direction and thus the connector 22 can move relative to the chassis 14 in the same direction according to the relative movement of the holding member 23.

Specifically, a predetermined clearance 27 is provided between the outer sidewall 23b2 of the holding member 23 located on the outer side in the X-axis direction and a rim of the mounting hold 14b as illustrated in FIG. 6. The sidewall 23b2 can move (or slide) in the X-axis direction within the clearance 27 with respect to the bottom plate 14a of the chassis 14. When the relative movement occurs, the sidewall 23b2 is elastically deformed with a connecting point between the sidewall 23b2 and the bottom 23a as a pivot point, and an elastic restoring force builds up. The sidewall 23b2 move outward in the X-axis direction with respect to the bottom plate 14a of the chassis 14. As an outer surface of the sidewall 23b2 located on an outer side in the X-axis direction comes close to the inner wall of the mounting hole 14b, it elastically deforms such that an angle of the slope with respect to the Z-axis direction increases. According to the relative movement of the sidewall 23b2, the stopper 23c moves in the same direction.

A part of the connector 22, specifically an outer end of the light source fitting portion 24a of the housing 24 is in contact with the inner surface of the sidewall 23b2. When a force is applied to the sidewall 23b2 by the connector 22 outward in the X-axis direction, the sidewall 23b2 is elastically deformed by the force and moves in the same direction. As a result, the connector 22 moves outward in the X-axis direction with respect to the chassis 14. When the force applied to the sidewall 23b2 that is elastically deformed (see FIG. 7) by the connector 22 is released, the force built up in the sidewall 23b2 is released as an elastic restoring force that restore the sidewall 23b2. As a result, the connector 22 moves inward in the X-axis direction with respect to the chassis 14. As described above, the connector 22 can move relative to the chassis 14 inward and outward in the X-axis direction.

The entire part of the connector 22 with the sidewall 23b2 of the holding member 23 does not move relative to the chassis 14. Only a part of the connector 22 moves relative to the chassis 14. Specifically, the board connecting portion 22b of the connector 22 is fixed without movement relative to the bottom plate 14a of the chassis 14, that is, it is a fixed position portion. The light source connecting portion 22a is a movable portion that can move relative to the bottom plate 14a. The light source connecting portion 22a can rotate with the board connecting portion 22b, which is a position fixed portion, as a pivot point along the X-axis direction. When the light source connecting portion 22a is moved outward in the X-axis direction with respect to the board connecting portion 22b, the light source connecting portion 22a is elastically deformed with respect to the board connecting portion 22b with a elastic restoring force built up, similar to the sidewall 23b2 of the holding member 23 explained earlier. The board connecting portion 22b is maintained at the fixed location with respect to the chassis 14. Therefore, the relative position of the board connecting portion 22b to the connection tab 21a of the inverter board 21 or the connecting condition are less likely to change regardless of the rotary movement of the light source connecting portion 22a.

As described above, the light source connecting portion 22a of the connector 22 can rotate with respect to the board connecting portion 22b or elastically deform. Therefore, the light source fitting portion 24a of the housing and the light source contacts 25b of the connecting terminal 25, which are included in the light source connecting portion 22a, rotate along the X-axis direction with the board fitting portion 24b of the housing 24 or the board contact 25c of the connecting terminal 25 as a pivot point and elastically deform. Namely, the housing 24 and the connecting terminal 25 of the connector 22 can be rotated or elastically deformed relative to the sidewall 23b2 of the holding member 23.

The present embodiment has the above structural features. Next, operations will be explained. When the liquid crystal display device 10 is turned on, power is supplied from the inverter boards 21 of the backlight unit 12 to the cold cathode tubes 18 via the connectors 22. As a result, the cold cathode tubes turn on. Image signals are sent to the liquid crystal panel 11. Light emitted from the cold cathode tubes 18 is converted to substantially uniform planar light after passing through the optical members 16 and illuminates the liquid crystal panel 11. The amount of transmitted light is controlled by aligning the liquid crystal molecules in the liquid crystal layer of the liquid crystal panel 11 based on the image signals. As a result, requested images are displayed on the display surface of the liquid crystal panel 11.

When the cold cathode tubes 18 turn on, each of them produces heat and heat expansion. As a result, the glass tube 18a and the outer leads 18b slightly extend in the axial direction of the cold cathode tube 18 (i.e., the X-axis direction). Namely, the outer leads 18b at the ends of the glass tube 18a are displaced outward in the X-axis direction (indicated by arrow A in FIG. 7) relative to the chassis 14. If the connector is totally fixed to the chassis such that no relative movement occurs, a friction is produced between the light source contact of each connecting terminal and the corresponding outer lead that are in contact with each other. As a result, abrasions or squeaks may be produced. Such abrasions could cause a contact failure between the connecting terminal and the outer lead. The user of the liquid crystal display device may be annoyed by the squeaks.

In this embodiment, the connector 22 can move relative to the chassis 14 in the axial direction of the cold cathode tube 18. Therefore, the relative position of the connector 22 to the cold cathode tube 18 in the axial direction of the cold cathode tube 18 is less likely to change. Specifically, when the cold cathode tube 18 thermally expands, outward pressing forces that press the ends of the glass tube 18a and the outer leads 18b against the respective light source fitting portions 24a or the respective light source contacts 25b are produced in the X-axis direction. Namely, the pressing forces work in directions that the outer leads 18b extend from the glass tube 18a (or directions away from the middle position of the cold cathode tube 18 in the axial direction). Before the pressing forces exceed the friction forces between the ends of the glass tube 18a and the respective light source fitting portions 24a that are in contact with each other and the friction forces between the outer leads 18b and the respective light source contacts 25b, the light source contacts 25b of the connecting terminals 25, the light source fitting portions 24a of the housings 24 and the outer sidewalls 23b2 of the holding members 23 located on outer sides in the X-axis direction are elastically deformed, as illustrated in FIG. 7.

Specifically, the clearance 27 is provided between the sidewall 23b2 of each holding member 23 and the rim of the mounting hole 14b of the chassis 14. Therefore, the sidewall 23b2 is elastically deformed as it can move relative to the bottom plate 14a outward in the X-axis direction within the clearance 27. In conjunction with that, the light source fitting portion 24a of each housing 24 and the light source contact 25b of each connecting terminal 25 are elastically deformed as they move relative to the bottom plate 14a in the same direction. According to the elastic deformations, elastic restoring forces that makes the parts return to the original shapes gradually build up in the sidewall 23b2 of the holding member 23, the light source fitting portion 24a of the housing 24 and the light source contact 25b of the connecting terminals 25. The light source connecting portion 22a (or the light source fitting portion 24a and the board contact 25b) of the connector 22 is rotated with the board connecting portion 22b (or the board fitting portion 24b and the board contact 25c) as a pivot point so as to move the position outward as indicated by arrow B in FIG. 7. Namely, the light source connecting portion 22a is a movable portion that rotates so as to move the position in the direction of thermal expansion of the cold cathode tube 18 (i.e., outward in the X-axis direction) when the cold cathode tube 18 thermally expands. Therefore, the relative position of the end of the glass tube 18a to the light source fitting portion 24a, which is in contact therewith, and the relative position of the outer lead 18b to the light source contact 25b are least likely to change, and thus the frictions are less likely to occur therebetween. Because the light source fitting portion 24a and the light source contact 25b of the light source connecting portion 22a rotate together and the relative positions of those are least likely to change, the frictions are less likely to occur therebetween. The board connecting porting 22b is a fixed position portion, the relative position of which to the chassis 14 is fixed. Even when the light source connecting portion 22a rotates according to the thermal expansion of the cold cathode tube 18, the relative positions of the connection tab 21a of the inverter board 21, which is fixed to the chassis 14, to the board connecting portion 22b is least likely to change. Therefore, the connection between them is stably maintained.

When the liquid crystal display device 10 is turned off, the power supply from the inverter boards 21 stops and the cold cathode tubes 18 turn off. The heat from the cold cathode tubes 18 dissipates and thus the cold cathode tubes 18 cool down as time elapses. Each cold cathode tube 18 that is thermally expanded gradually contracts back to the original size (in the condition illustrated in FIG. 6). The ends of the glass tube 19a and the outer leads 18b move relative to the chassis 14 inward in the axial direction of the cold cathode tube 18. The outward pressing forces applied to the light source fitting portions 24a and the light source contacts 25b by the ends of the glass tube 18a and the outer leads 18b are released. As a result, the elastically deformed light source fitting portions 24a and the elastic restoring forces built up in the light source contacts 25b and the sidewalls 23b2 are released. With the elastic restoring forces, the connectors 23 move relative to the chassis 14 inward in the axial direction of the cold cathode tube 18 (i.e., in the direction opposite to the direction of the thermal expansion) according to the thermal contraction of the cold cathode tube 18. The light source connecting portion 22a of each connector 22 rotates inward with the board connecting portion 22 as a pivot point. Namely, the light source connecting portion 22a rotates so as to move in the contracting direction (or inward in the X-axis direction) according to the thermal contraction of the cold cathode tube 18. When the cold cathode tube 18 turns off, the relative position of the end of the glass tube 18a to the light source fitting portion 24a that is in contact therewith and the relative position of the outer lead 18b to the light source contact 25b do not change. Therefore, the frictions are less likely to occur therebetween. Because the relative position of the light source fitting portion 24a to the light source contact 25b does not change, the friction therebetween is less likely to occur.

As described above, the relative position of the light source connecting portion 22a of the connector 22 to the chassis 14 changes according to the thermal expansion or the thermal contraction of the cold cathode tube 18. As a result, the relative position of the connector 22 to the cold cathode tube 18 is maintained. Therefore, the frictions are less likely to occur in a contact area between the cold cathode tube 18 and the connector 22 or between the housing 24 of the connector 22 and the connecting terminal 25. Namely, the abrasions and the squeaks are less likely to be produced in those areas.

In the above description, the thermal expansion and the thermal contraction of the cold cathode tubes 18 are the causes of the movements of the cold cathode tubes 18 relative to the chassis 14 in the X-axis direction. However, the movements of the cold cathode tubes 18 relative to the chassis 14 in the X-axis direction may be caused by impacts or vibrations during transport of the liquid crystal display device 10, for example. Even in such a case, the frictions between each outer lead 18b and the corresponding connecting terminal 25 or each housing 24 and the corresponding connecting terminal 25 are less likely to occur because the connector 22 can move relative to the chassis in the X-axis direction.

As described above, the backlight unit 12 includes the cold cathode tubes 18, the chassis 14 and the connectors 22. Each cold cathode tube 18 has the outer leads 18b at the ends. The chassis 14 houses the cold cathode tubes 18. The connectors 22 are mounted to the chassis 14 and connected to the respective outer leads 18b. The connectors 22 are configured to be movable to the chassis 14 in the axial directions thereof.

Even when the cold cathode tubes 18 move relative to the chassis 14 in the axial directions thereof, the connectors 22 can move relative to the chassis 14 in the same directions. Therefore, the frictions are less likely to occur in the contact areas between the outer leads 18b of each cold cathode tube 18 and the respective connectors 22 and thus the abnormal sounds or the abrasions are less likely to occur.

Each connector 22 includes the connecting terminal 25 and the housing 24. The connecting terminal 25 is electrically connected to the corresponding outer lead 18b. The housing 24 houses the connecting terminal 25 and is mounted to the chassis 14. The connecting terminal 25 and the housing 24 are both configured to be movable relative to the chassis 14 in the axial direction of the cold cathode tube 18. Therefore, the frictions between the terminal and the outer lead 18b or between the terminal and the housing 24 are less likely to occur.

The connectors 22 can move relative to the chassis 14 outward in the axial directions of the cold cathode tubes 18 when the cold cathode tubes 18 turn on. When the cold cathode tubes 18 thermally expand after they turn on, the outer leads 18b move relative to the chassis 14 outward in the axial directions of the cold cathode tubes 18. In conjunction with the relative movements of the outer leads 18b, the connectors 22 move relative to the chassis 14 in the same directions. Therefore, the frictions between the connectors 22 and the outer leads 18b are effectively controlled to occur.

The connectors 22 are movable relative to the chassis 14 along with elastic deformation. When the cold cathode tubes 18 thermally expand after they turn on, the connectors 22 elastically deform and move relative to the chassis 14 outward in the axial directions of the cold cathode tubes 18 in conjunction with the relative movements of the outer leads 18b. As a result, the elastic restoring forces are built up in the connectors 22. When the cold cathode tubes 18 thermally contract after they turn off, the outer leads 18b move relative to the chassis 14 inward in the axial directions of the cold cathode tubes 18. Due to the elastic restoring forces built up therein, the connectors 22 move relative to the chassis 14 inward in the axial directions of the cold cathode tubes 18 in conjunction with the relative movements of the outer leads 18b. Therefore, the frictions are less likely to occur after the cold cathode tubes 18 turn off.

Each connector 22 has the light source connecting portion 22a at one end and the board connecting portion 22b at the other end. The light source connecting portion 22a is connected to the outer lead 18b of the cold cathode tube 18. The board connecting portion 22b is a fixed position portion that is fixed to the chassis 14. The light source connecting portion 22b of the connector 22 can move relative to the chassis 14 with the board connecting portion 22b as a pivot point. Because the light source connecting portion 22b of the connector 22 can move relative to the chassis 14 with the board connecting portion 22b as a pivot point, the frictions are less likely to occur between the connector 22 and the outer lead 18b. The board connecting portion 22b is fixed to the chassis 14. This establishes stable connection between the board connecting portion 22b and the inverter board 21.

Each connector 22 is rotatable with the board connecting portion 22b as a pivot point. Because the connector 22 can rotate with the board connecting portion 22b as a pivot point, the frictions are less likely to occur between the connector 22 and the outer lead 18b.

Each inverter board 21 has connection tabs 21 that project from parts of the inverter board 21 toward the respective connectors 22 and are connected to the board connecting portions 22b. With this configuration, the inverter board 21 can be directly connected to the connectors 22 without requiring other connecting parts.

The holding members 23 for holding the connectors 22 are mounted to the chassis 14. The holding members 23 can move relative to the chassis 14 in the axial directions of the cold cathode tubes 18. Because the holding members 23 can move relative to the chassis 14 in the axial directions of the cold cathode tubes 18, the connectors 22 held with the holding members 23 can move relative to the chassis 14 in the same direction. Therefore, the frictions are less likely to occur in the contact areas between the connectors 22 and the outer leads 18b.

The liquid crystal display device 10 of this embodiment includes the backlight unit 12 and the liquid crystal display panel 11 that provides display using light from the backlight unit 12. Because the backlight unit 12 that illuminates the liquid crystal panel 11 is less likely to produce the abnormal sounds or the abrasions between the outer leads 18b and the connectors 22, the liquid crystal display device 10 can be provided with improved quality and reliability.

### Second Embodiment

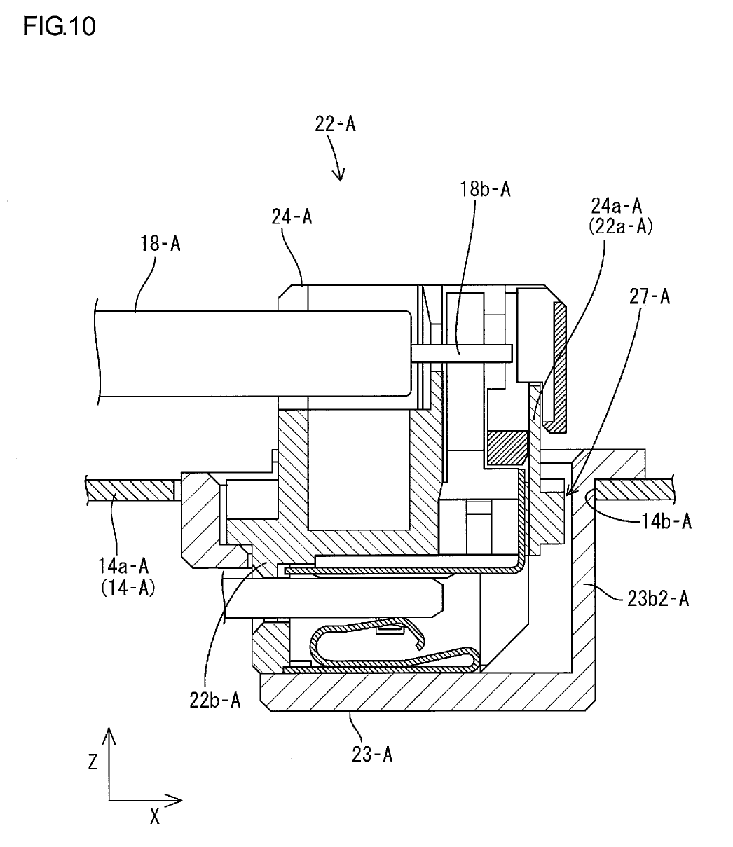

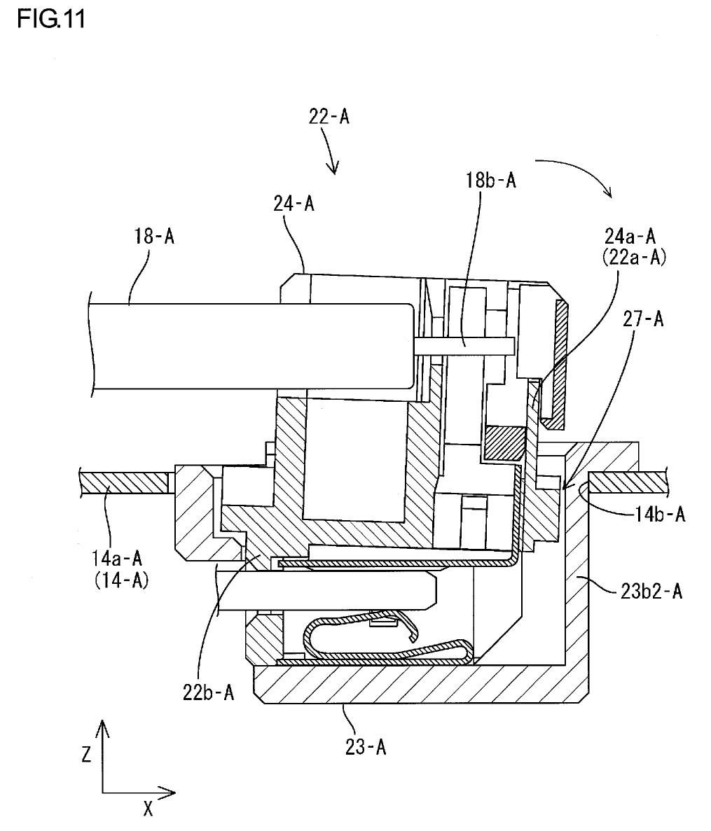

The second embodiment of the present invention will be explained with reference to FIGS. 10 and 11. In this embodiment, holding members 23-A are fixed to the chassis 14-A. The same parts as the first embodiment will be indicated by the same symbols followed by “-A.” Structure, operations and effects same as the first embodiment will not be explained.

As illustrated in FIG. 10, each holding member 23-A is mounted to a bottom plate 14a-A of the chassis 14-A with a part thereof inserted in a mounting hole 14b-A and a small clearance. Specifically, only a small clearance is provided between a sidewall 23b2-A of the holding member 23-A located on an outer side in the X-axis direction and a rim of the mounting hole 14b-A of the bottom plate 14a-A. The clearance is just large enough to allow the mounting of the holding member 23-A but not large enough to accept thermal expansion of a cold cathode tube 18-A.

A predetermined clearance 27-A is provided between a connector 22-A and the holding member 23-A in the X-axis direction. The connector 22-A can move relative to the holding member 23-A in the X-axis direction within the clearance 27-A. Specifically, the clearance 27-A is provided between a light source fitting portion 24a-A of the housing 24-A and the sidewall 23b2-A of the holding member 23-A located on the outer side in the X-axis direction. As illustrated in FIG. 11, a light source connecting portion 22a-A can rotate with a board connecting portion 22b-A as a pivot point so as to move outward in the X-axis direction. The clearance 27-A between the connector 22-A and the holding member 23-A is large enough to accept the thermal expansion of the cold cathode tube 18-A.

As described above, the holding members 23-A for holding the connectors 22-A are mounted to the chassis 14-A and fixed to the chassis 14-A. The connectors 22-A can move relative to the respective holding members 23-A in the axial directions of the cold cathode tubes 18-A. Because the connectors 22-A can move relative to the respective holding members 23-A fixed to the chassis 14-A in the axial directions of the cold cathode tubes 18-A, frictions are less likely to occur in contact areas between the connectors 22-A and the respective outer leads 18b-A.

### Third Embodiment

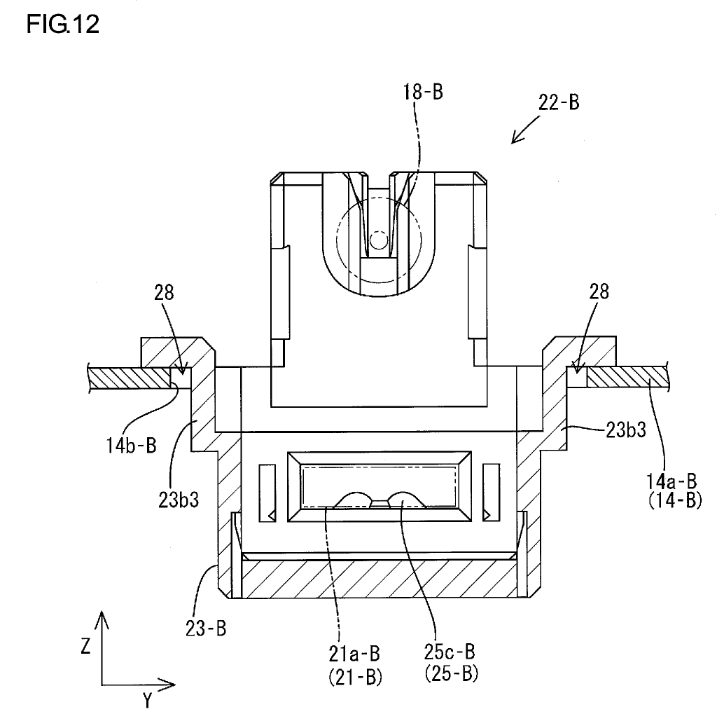

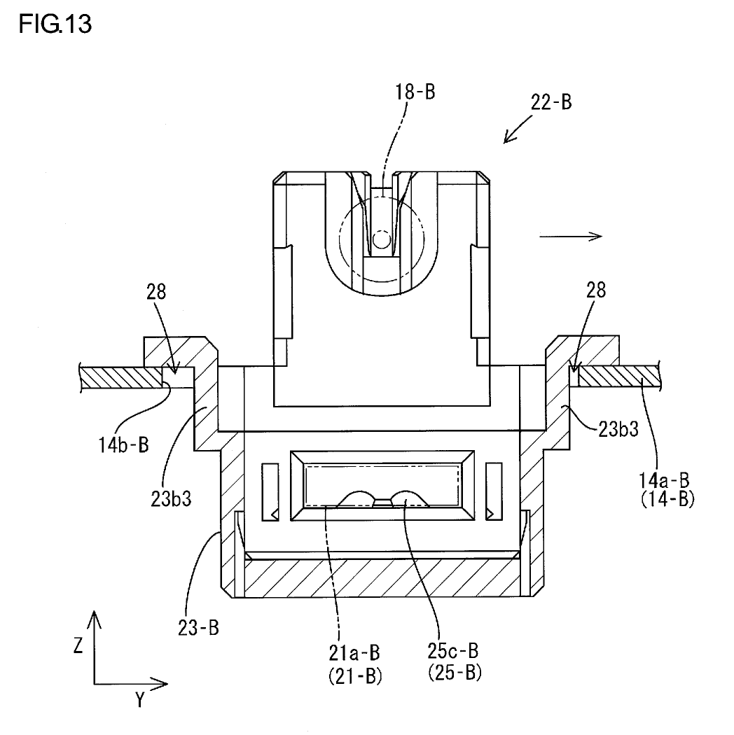

The third embodiment of the present invention will be explained with reference to FIGS. 12 and 13. In this embodiment, a configuration that accept thermal expansions and contracts of inverter boards 21-B. In this embodiment, the same parts as the first embodiment will be indicated with the same symbols followed by “-B.” Structures, operations and effects same as the first embodiment will not be explained.

As illustrated in FIG. 12, each holding member 23-B is mounted to a chassis 14-B with a part thereof inserted in a mounting hole 14b-B of a bottom plate 14a-B of the chassis 14 and predefined clearances 28 in the Y-axis direction. Specifically, the clearances 28 are provided between sidewalls 23b3 of the holding member 23-B located on outer sides in the Y-axis direction and a rim of the mounting hole 14b-B of the bottom plate 14a-B. Therefore, the connector 22-B can move relative to the bottom plate 14a-B in the Y-axis direction within the clearances 28.

When the liquid crystal display device is turned on, thermal expansions occur not only in the cold cathode tubes 18-B but also inverter boards 21-B. Because each inverter board 21-B has an elongated shape extends along the Y-axis direction (see FIG. 5), an amount of thermal expansion thereof is larger in the X-axis direction than in the Y-axis direction. Each connection tab 21a-B moves relative to the bottom plate 14a-B of the chassis 14-B in the Y-axis direction by the amount of thermal expansion in the Y-axis direction. When the thermal expansion occurs in each inverter board 21-B, each connector 22-B moves relative to the bottom plate 14a-B in the Y-axis direction within the clearances 28, as illustrated in FIG. 13. Namely, the thermal expansion of each inverter board 21-B can be compensated.

Specifically, when the connection tab 21a-B moves relative to the bottom plate 14a-B in a direction indicated by an arrow in FIG. 13 from the position illustrated in FIG. 12 according to the thermal expansion, the board connecting portion 22b-B of the connector 22-B is pressed by the connection tab 21a-B in the same direction. As a result, the connector 22-B moves relative to the bottom plate 14a-B in the Y-axis direction in conjunction with the relative movement of the connection tab 21a-B. When the connection tab 21a-B moves relative to the bottom plate 14a-B in the opposite direction to the direction indicated by the arrow in FIG. 13, the connector 22-B also moves relative to the bottom plate 14a-B in conjunction with the relative movement of the connection tab 21a-B. With the relative movements of the connectors 22-B, the thermal expansions of the inverter boards 21-B are compensated and the relative positions between the connectors 22-B and the respective connection tabs 21a-B in the Y-axis direction can be substantially maintained. Therefore, the frictions are less likely to occur between the connection tabs 21a-B and board contacts 25c-B of the respective connecting terminals 25-B and thus abrasions and squeaks are less likely to occur therebetween.

When the liquid crystal display device is turned off, the inverter boards 21-B may thermally contract. In such a case, the connectors 22-B move relative to the bottom plate 14a-B in the Y-axis direction within the clearances. Therefore, the relative positions between the connection tabs 21a-B and the respective connectors 22-B are maintained and thus the abrasions and squeaks are less likely to occur.

Each inverter board 21-B of this embodiment has a rectangular shape, the long-side direction of which is perpendicular to the axial direction of the cold cathode tubes 18-B. Each connector 22-B can move relative to the chassis 14-B in the long-side direction of the inverter board 21-B. When the inverter board 21-B thermally expands or contracts in the long-side direction thereof, the connectors 22-B move relative to the chassis 14-B in the long-side direction of the inverter board 21-B. Therefore, the frictions are less likely to occur in the contact areas between the connectors 22-B and the inverter boards 21-B.

### Other Embodiments

The present invention is not limited to the above embodiments explained in the above description. The following embodiments may be included in the technical scope of the present invention, for example.
(1) In the first embodiment, a clearance is not provided between each connector and the corresponding holding member to allow the relative movement of the connector. However, one that having such a clearance may be provided, that is, a combination of the first embodiment and the second embodiment is included in the scope of the present invention. With the clearance in conjunction with the clearance between the holding member and the chassis, abrasions and squeaks can be more reliably reduced.
(2) In the first and the second embodiments, the deformable connectors are used. However, connectors that are not deformable and configured to be movable relative to the chassis in the axial direction of the cold cathode tubes are included in the scope of the present invention. Specifically, the board connecting portion and the light source connecting portion of each connector are prepared as two separate parts, and the two parts are assembled such that they are movable relative to the chassis in the axial direction of the cold cathode tube. Furthermore, connectors, entire parts of which move relative to the chassis in the axial direction of the cold cathode tubes and in which elastic restoring forces are not built up are included in the scope of the present invention.
(3) In the first and the second embodiments, the light source connecting portion of each connector can rotate with the board connecting portion as a pivot point. However, connectors, entire parts of which move relative to the chassis in the axial directions of the cold cathode tubes without rotary movements are included in the scope of the present invention.
(4) The shapes each connector (housing, connecting terminal and terminal pressing member) and each holding member or the mounting structures thereof to the chassis can be altered from the above embodiments as necessary. For example, the holding member can be mounted to the front surface of the bottom plate of the chassis.
(5) In the above embodiments, each connector includes the terminal pressing member. However, connectors without terminal pressing members are also included in the scope of the present invention.
(6) In the above embodiments, the connectors are indirectly mounted to the chassis via the holding members. However, connectors directly mountable to the chassis without holding members are also included in the scope of the present invention.
(7) In the above embodiments, the board contact of each connecting terminal is provided at the outer wall of the barrel-like portion. However, the board contact can be provided at the inner wall of the barrel-like portion. The board contacts may be provided in pairs similar to the light source contacts. Furthermore, connecting terminals each having a single light source contact similar to the board contacts rather than a pair of the light source contacts are also included in the scope of the present invention.
(8) In the above embodiments, the connection tabs of the inverter boards are directly fitted and connected to the connectors. However, FPCs may be connected to the inverter boards without connection tabs and the connectors. Such a configuration having FPCs that make connection between the inverter boards and the connectors is also included in the scope of the present invention.
(9) In the above embodiments, each cold cathode tube includes the outer leads at the ends of the glass tube and the connectors are connected to the outer leads. However, cold cathode tubes each having ferrules fitted onto ends of a glass tube and connected to outer leads and connectors are also included in the scope of the present invention.
(10) In the above embodiments, the straight-tube-type cold cathode tubes are used. However, a lighting unit including curved-tube-type cold cathode tubes such as U-shaped cold cathode tubes is also included in the scope of the present invention.
(11) The cold cathode tubes are used in the above embodiments as linear light sources. However, hot cathode tubes or other types of liner light sources tubes can be used.
(12) In the above embodiments, the TFTs are used as switching components in the liquid crystal display device. The disclosed technologies can be applied to liquid crystal display devices that use switching components other than the TFTs, such as thin film diodes (TFDs). Furthermore, the technologies can be applied to black-and-white display devices other than color liquid crystal display devices.
(13) The liquid crystal display devices using the liquid crystal panels are used as examples in the above embodiments. However, the present invention can be applied to display devices using other types of display panels.
(14) The television receivers having tuners are used in the above embodiments. However, the present invention can be applied to display devices without tuners.

1. A lighting device comprising:
a linear light source having external connection portions at ends;
a chassis hosing the linear light source; and
connectors mounted to the chassis, connected to the external connection portions and configured to be movable relative to the chassis in an axial direction of the linear light source.

2. The lighting device according to claim 1, wherein:
each of the connectors includes a connecting terminal electrically connected to the corresponding external connection portion, and a housing that houses the connecting terminal and is mounted to the chassis; and
the connecting terminal and the housing are configured to be movable relative to the chassis in an axial direction of the linear light source.

3. The lighting device according to claim 1, wherein the connectors are configured to be movable relative to the chassis outward in the axial direction of the linear light source according to turn-on of the linear light source.

4. The lighting device according to claim 3, the connectors are configured to be movable relative to the chassis along with elastic deformation.

5. The lighting device according to claim 1, wherein:
each of the connector includes a light source connecting portion connected to the external connection portion of the linear light source at one end and a fixed position portion fixed to the chassis at another end; and
the light source connecting portion is configured to be movable relative to the chassis with the fixed position portion as a pivot point.

6. The lighting device according to claim 5, wherein each of the connectors is configured to be rotatable with the fixed position portion as a pivot point.

7. The lighting device according to claim 5, further comprising power circuit boards configured to supply power to the linear light source fixed to the chassis, wherein the fixed position portions include board connecting portions connected to the respective power circuit boards.

8. The lighting device according to claim 7, further comprising connection tabs projecting from parts of the respective power circuit boards toward the respective connectors and connected to the respective board connecting portions.

9. The lighting device according to claim 7, wherein:
each of the power circuit board has a rectangular shape and is arranged such that a long-side direction thereof is perpendicular to the axial direction of the linear light source; and
the connectors are configured to be movable relative to the chassis in the long-side direction of the respective power circuit boards.

10. The lighting device according to claim 1, further comprising holding members that hold the connectors, wherein the holding members are mounted to the chassis and configured to be movable relative to the chassis in the axial direction of the linear light source.

11. The lighting device according to claim 1, further comprising holding members that hold the connectors, wherein:
the holding members are fixed to the chassis; and
the connectors are configured to be movable relative to the respective holding members in the axial direction of the linear light source.

12. A display device comprising:
the lighting device according to claim 1; and
a display panel configured to provide display using light from the lighting device.

13. The display device according to claim 12, wherein the display panel is a liquid crystal panel including liquid crystals between a pair of substrates.

14. A television receiver comprising the display device according to claim 12.
